(19) United States
(12) Patent Application Publication
(10) Pub. No.: US 2017/0087474 A1
(43) Pub. Date: Mar. 30, 2017

(54) SYSTEM FOR GENERATING SCENARIOS TO EVALUATE THEIR ANALYTICAL ABILITY ON THE SCENARIOS RAISED DURING THE VIRTUAL GAME

(71) Applicants: Heng Ping Nabil Christopher Moh, NEW YORK, NY (US); AMARJOT THIARA, BRAMPTON (CA)

(72) Inventors: Heng Ping Nabil Christopher Moh, NEW YORK, NY (US); AMARJOT THIARA, BRAMPTON (CA)

(73) Assignee: Sports Maximization Inc., BRAMPTON (CA)

(21) Appl. No.: 15/363,265

(22) Filed: Nov. 29, 2016

Related U.S. Application Data
(63) Continuation-in-part of application No. 15/259,327, filed on Sep. 8, 2016.
(60) Provisional application No. 62/322,294, filed on Apr. 14, 2016.
(60) Provisional application No. 62/234,753, filed on Sep. 30, 2015.

(51) Int. Cl. A63F 13/828; A63F 13/46; A63F 13/798; A63F 13/35; A63F 13/537

(52) U.S. Cl. CPC A63F 13/828; A63F 13/35; A63F 13/537; A63F 13/798; A63F 13/46

(57) ABSTRACT

Disclosed is a system for generating scenarios during a virtual game played by a user. The virtual game represents a real sports game received from a media feed. The system includes a user database for storing information about users; a sports database for storing information related to each sport, each game move for each sport; a scenario database for storing multiple scenarios related to the real sports game; a scenario model module coupled with the sports database and the scenario database, the scenario model module determines the best scenario for the current state of the real sports game; a decision model module calculates a score based upon the response on the scenario by the user using statistical information of teams and players, and rules and regulations; and a processor processes a data stream of the real sports game received from the media feed. The processor includes a game data module to display the current state of the virtual game extracted from the real sports game received from the media feed; a scenario move module to display at least one scenario along with plurality of choices and further the scenario move module allows the user to select at least one of the plurality of choices; and a score module displays the score associated with user's selected choice for the displayed scenario, wherein the score provides the user with feedback on their analytical ability on the scenarios raised during the virtual game.

### CROSS REFERENCE TO RELATED APPLICATION

The present application is a continuation-in-part of U.S. patent application Ser. No. 15/259,327, filed Sep. 8, 2016, which further claims the benefit under 35 U.S.C. §119(e) of U.S. Provisional Patent Application No. 62/234,753 filed Sep. 30, 2015, which is incorporated herein by reference in its entirety and made a part hereof. This application also claims the benefit under 35 U.S.C. §119(e) of U.S. Provisional Patent Application No. 62/322,294 filed Apr. 14, 2014, which is incorporated herein by reference in its entirety and made a part hereof.

### BACKGROUND OF THE INVENTION

Almost a decade ago, the only way to connect with an ongoing live event was either by watching it on TV or by attending the event in person. With the increasing use of web-based (or internet based) interconnected computing devices, which may include, but are not limited to, laptops, cellphones, tablets, desktop computers and smart TVs, more and necessary people are engaging with alive event by constantly checking on updates through various online social networks (Facebook, Twitter, Instagram, etc.) or by watching it “on the go” through webcasts or podcasts.

In the specific case of sporting events, people also like to check on latest scores and various updates, such as decisions made by coaches, managers, captains or any other on-field decision-maker in a specific game play scenario. Those watching these events on a TV or in person also like to check web-based media to access past or present statistics related to the sporting event, analysis by experts, and similar information which have not traditionally been available to them.

During the game play there could be one or more decision-making situations at various points. However, there could be multiple possible decision-making scenarios at a given point of the game play depending upon the on-field and off-field situations which the average viewer may not know about but would like to know and learn about as it would also improve his or her knowledge of the sport.

At present, there are several computer games which simulate real life sporting events. These games allow a user to interact with the simulated game environment based on a pre-defined set of parameters. However, these computer games usually lack the ability to fully appreciate the various possible decision-making scenarios and fail to make the user aware of the scenarios. Further, none of these existing systems may be used for an educational purpose to learn more about the finer aspects of sports and offer only some entertainment value.

Therefore, there is a need for a system and a method to allow a user to develop a deeper understanding of a sports event by learning about the finer points of the various decision making scenarios possible during the sports event. Further, the system and the method should preferably use a game-like format for better user engagement.

### SUMMARY OF THE INVENTION

In accordance with the teachings of the present invention, a system for generating scenarios during a virtual game played by user is provided.

An object of the present invention is to provide a system for generating scenarios during a virtual game played by user, wherein the virtual game represents a real sports game received from a media feed. The system includes a user database, a sports database, a scenario database, a scenario model module, a decision model module, and a processor. The processor includes a game data module, a scenario move module and a score module.

The user database stores information about users. The sports database stores information related to each sport, each game move for each sport, rules and regulations associated with each sport and updated real-time statistics of each team and each player playing the sport. The scenario database stores multiple scenarios related to the real sports game.

The scenario model module is coupled with the sports database and the scenario database. Further, the scenario model module determines the best scenario for the current state of the real sports game. The decision model module is coupled with the sports database and the scenario model module. The decision model module further calculates a score based upon the response on the scenario by the user using statistical information of teams and players, and rules and regulations.

The processor is coupled with the user database, the sports database, the scenario database, the decision model module, and the scenario module. The processor processes a data stream of the real sports game received from the media feed. The game data module displays the current state of the virtual game extracted from the real sports game received from the media feed.

The scenario move module displays at least one scenario along with plurality of choices and further the scenario move module allows the user to select at least one of the plurality of choices and further the scenario move module allows the user to select at least one of the plurality of choices. The score module displays the score associated with the user's selected choice for the displayed scenario. The score provides the user with feedback on their analytical ability on the scenarios raised during the virtual game.

Another object of the present invention is to provide a rank module to display the rank of the user among all users playing the virtual game, wherein the rank is determined by ranking users scores, wherein the score of the user is calculated by the decision model module from the user's selected choice for the scenario.

Another object of the present invention is to provide an average module to calculate the average score of the user from all the choices for the given scenario selected by the user. Another object of the present invention is to provide a challenge module to allow each user to challenge at least one of the other registered users.

Another object of the present invention is to provide an energy module to display the remaining energy of the user to play the virtual game. Another object of the present invention is to provide a game move module to display the challenging game move for the current state of the virtual game, wherein decision model module determines a possible game move from the current on-field state of the real game.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a block diagram of a system for generating scenarios during a virtual game in accordance with a preferred embodiment of the present invention;

FIG. 2 illustrates a screenshot showing of the game data module, the scenario move module and the score module in accordance with a preferred embodiment of the present invention;

FIG. 3 illustrates a screenshot showing of the scenario move model in another preferred embodiment of the present invention; and

FIG. 4 illustrates a screenshot showing of the scenario move model in another preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, a decision making system for generating scenarios during a virtual game played by a user may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

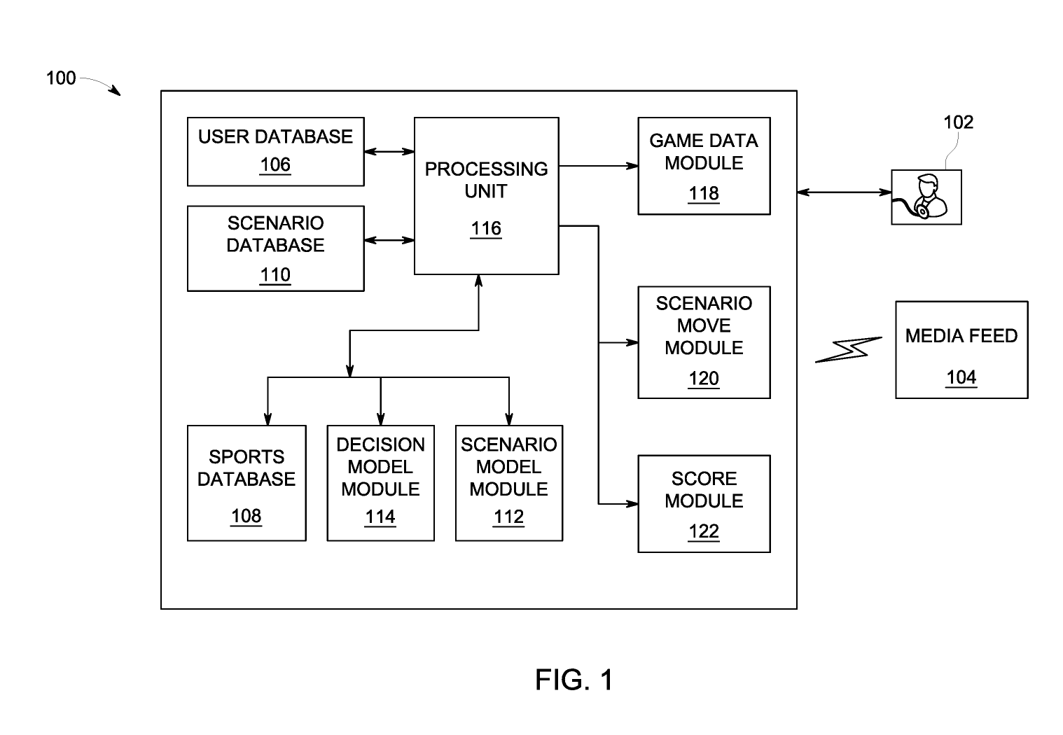

FIG. 1 illustrates a block diagram of a system 100 for generating scenarios during a virtual game played by a user 102. The virtual game represents a real sports game received from a media feed 104. The system 100 includes a user database 106 for storing information about users 102, and a sports database 108 for storing information related to each sport, each game move for each sport, rules and regulations associated with each sport, and updated real-time statistics of each team and each player playing the sport.

The system 100 further includes a scenario database 110 for storing multiple scenarios related to the real sports game, a scenario model module 112 is coupled with the sports database 108 and the scenario database 110. The scenario model module 112 determines the best scenario for the current state of the real sports game. In a preferred embodiment of the present invention, the scenario database 110 is a library of various scenarios created with respect to various on-field situations in the real sports game.

The system 100 further includes a decision model module 114 coupled with the sports database 108 and the scenario model module 112. Further, the decision model module 114 calculates a score based upon response the on the scenario by the user using statistical information of teams and players, and rules and regulations. The scenario model module 112 chooses a scenario based upon various factors including but not limited to educational and interest value.

The system 100 further includes a processor 116 coupled with the user database 106, the sports database 108, the scenario database 110, the decision model module 114 and the scenario model module 112. The processor 116 processes a data stream of the real sports game received from the media feed 104. The processor 116 includes a game data module 118, a scenario move module 120 and a score module 122.

The game data module 118 displays the current state of the virtual game extracted from the real sports game received from the media feed. The scenario move module 120 displays at least one scenario along with the plurality of choices. Further, the scenario move module 120 allows the user to select at least one of the plurality of choices.

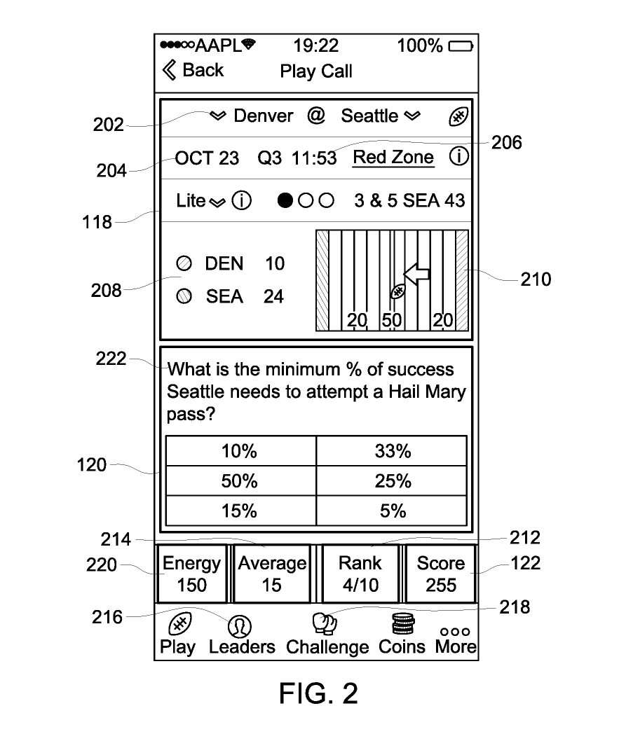

The score module 122 displays the score associated with user's selected choice for the displayed scenario. The score provides the user with feedback on their analytical ability on the scenarios raised during the virtual game. The game data module 118, the scenario move module 120 and the score module 122 is explained in detail in conjunction with FIG. 2 of the present invention.

FIG. 2 illustrates a screenshot showing of the game data module 118, the scenario move module 120 and the score module 122 in accordance with a preferred embodiment of the present invention. With reference to FIG. 1, the game data module 118 displays the current state of the virtual game extracted from the real sports received from the media feed.

In a preferred embodiment of the present invention, the game data module 118 displays the name of two sports teams playing the real sports game. For exemplary purposes, as shown in FIG. 2, the two sports teams, Denver and Seattle are playing football as shown in 202. Further, the game data module 118 discloses the date 204 of the match which in the example is October 23.

Furthermore, the game data module 118 displays the current on-field situation 206 of the real game. In an exemplary embodiment, the current on-field situation 206 is Quarter 3 (Q3) with remaining time 11:53. Further, the game data module 118 shows the current score 208. In an exemplary embodiment, the current score 208 shown is Denver 10 Seattle 24.

Furthermore, the game data module 118 displays a screen 210 to display the current on-field situation of the game received through the media feed. In an exemplary embodiment, the screen 210 displays the position of the ball at Seattle's 43-yard line.

It would be apparent to those skilled in the art that various data may be envisioned through the game data module 118 without deviating from the scope of the present invention. In a preferred embodiment of the present invention, the game data module 118 displays data from a game of football. However, it would be readily apparent to those skilled in the art that various games may be envisioned without deviating from the scope of the present invention.

With reference to FIG. 1, the scenario move module 120 displays at least one scenario along with a plurality of choices. Further the scenario move module 120 allows the user to select at least one of the plurality of choices. In an exemplary embodiment of the present invention, the scenario move module 120 displays a scenario 222 i.e. “What is the minimum % of success Seattle needs to attempt a Hail Mary pass?”

Further in an exemplary embodiment, the plurality of choices for the above scenario are 10%, 33%, 50%, 25%, 15%, and 5%. The user is able to select at least one of the plurality of choices. Thereafter, the score module 122 displays the score associated with user's selected choice for the displayed scenario. In another exemplary embodiment as shown in FIG. 2, the score module 122 displays accumulated score i.e. 255.

In another preferred embodiment of the present invention, the processing system further includes a rank module 212 to display the rank of the user among all users playing the virtual game. The rank is determined by ranking users' scores, wherein the scores are calculated by the decision model module from users' choices. In an exemplary embodiment as shown in FIG. 2, the rank of the user is 4/10.

In another preferred embodiment of the present invention, the processing system further includes an average module 214 to calculate the average score of the user from all the game moves selected by the user to manage the virtual game up to its current state.

In an exemplary embodiment as shown in FIG. 2, the average score of the user is 15. In another preferred embodiment of the present invention, the processing system further includes an energy module 220 to display the remaining energy of the user to play the virtual game.

In another preferred embodiment of the present invention, the processing system further includes a leader module 216 to display the list of leaders from all users based on scores calculated through the score module 122. Further, in another preferred embodiment, the processing system further includes a challenge module 218 to allow a user to challenge at least one of the other registered users.

In another exemplary embodiment of the present invention, the processing system further includes a game move module to display the challenging game move for the current state of the virtual game. The decision model module determines a possible game move from the current on-field state of the real game.

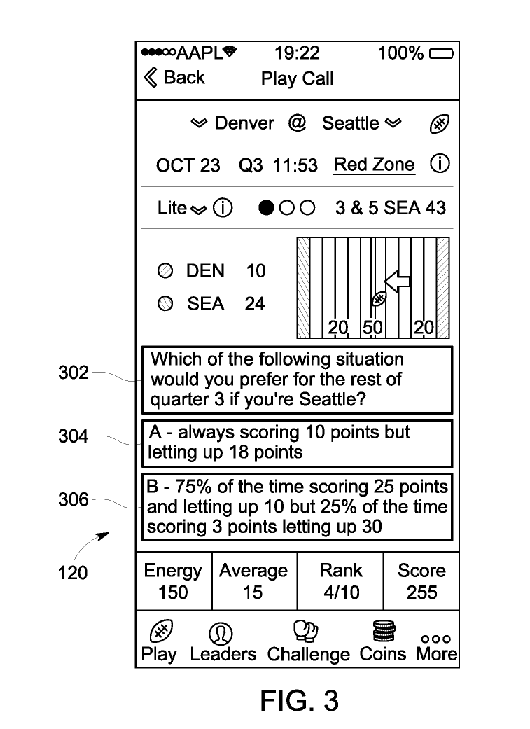

FIG. 3 illustrates a screenshot showing of the scenario move model 120 in another preferred embodiment of the present invention. In an exemplary embodiment, the scenario move model 120 displays a scenario 302 i.e. which of the following situation would you prefer for the rest of quarter 3 if you're Seattle?

Examples of the plurality of choices A 304: always scoring 10 points but letting up 18 points and B 306: 75% of the time scoring 25 points and letting up 10 but 25% of the time scoring 3 points letting up 30. The user selects at least one of the A 304 and the B 306 for the scenario 302. The score provides the user with feedback on their analytical ability on the scenarios raised during the virtual game.

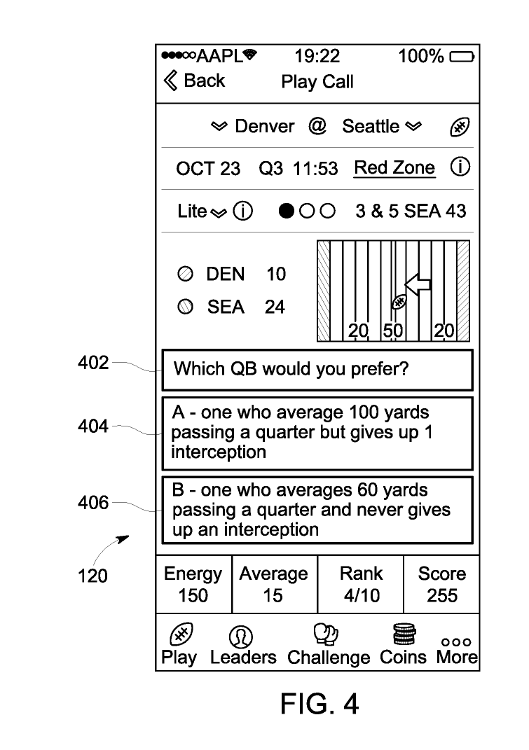

FIG. 4 illustrates a screenshot showing of the scenario move model 120 in another preferred embodiment of the present invention. In an exemplary embodiment, the scenario move model 120 displays a scenario 402 i.e. Which Quarterback (QB) would you prefer?

Examples of the plurality of choices A 404: one who average 100 yards passing a quarter but gives up 1 interception and B 306: one who averages 60 yards passing a quarter and never gives up an interception. The user selects at least one of the A 404 and the B 406 for the scenario 402. The score provides the user with feedback on their analytical ability on the scenarios raised during the virtual game.

The present invention offers various advantages such as providing users a gaming platform to evaluate their decision making performance. Further, the present invention allows users to get involved in the on-field sport game and thus makes the game watching process more interactive. Further, the present invention provides a virtual social game that allows users to compete with their friends as they watch the real sports game. Further, the present invention allows coaches to make more insightful decisions in the game using real time data, statistics, game rules and regulations.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for generating scenarios during a virtual game played by a user, wherein the virtual game represents a real sports game received from a media feed, the system comprising:
a user database for storing information about users;
a sports database for storing information related to each sport, each game move for each sport, rules and regulations associated with each sport, and updated real-time statistics of each team and each player playing the sport;
a scenario database for storing multiple scenarios related to the real sports game;
a scenario model module coupled with the sports database and the scenario database, the scenario model module determines the best scenario for the current state of the real sports game;
a decision model module coupled with the sports database and the scenario model module, further the decision model module calculates a score based upon the response on the scenario by the user using statistical information of teams and players, and rules and regulations; and
a processor coupled with the user database, the sports database, the scenario database, the decision model module, and the scenario model module; wherein the processor processes a data stream of the real sports game received from the media feed, the processor comprising:
a game data module to display the current state of the virtual game extracted from the real sports game received from the media feed;
a scenario move module to display at least one scenario along with plurality of choices and further the scenario move module allows the user to select at least one of the plurality of choices; and
a score module displays the score associated with user's selected choice for the displayed scenario, wherein the score provides the user with feedback on their analytical ability on the scenarios raised during the virtual game.

2. The system according to claim 1 wherein the processor further comprising a rank module to display the rank of the user among all users playing the virtual game, wherein the rank is determined by ranking users scores, wherein the score of the user is calculated by the decision model module from the user's selected choice for the scenario.

3. The decision making system according to claim 1 wherein the processor further comprising an average module to calculate the average score of the user from all the choices for the given scenario selected by the user.

4. The decision making system according to claim 1 wherein the processor further comprising a leader module to display the list of leaders of all the users on the basis of scores calculated through the score module in playing the virtual game.

5. The decision making system according to claim 1 wherein the processor further comprising a challenge module to allow each user to challenge at least one of the other registered users.

6. The decision making system according to claim 1 wherein the processor further comprising an energy module to display the remaining energy of the user to play the virtual game.

7. The decision making system according to claim 1 wherein the game data module displays the name of two sports teams playing the real sports game.

8. The decision making system according to claim 1 wherein the game data module displays a playing date of the real sports game relayed from the media feed.

9. The decision making system according to claim 1 wherein the game data module displays the current score of each team playing the real sports game.

10. The decision making system according to claim 1 wherein the game data module displays the current on-field situation of the game received through the media feed.

11. The decision making system according to claim 1 wherein the sport event is at least one of: Football; Baseball; Tennis.

12. The decision making system according to claim 11 wherein the screen displays yards, number of downs remaining, and time remaining in Football.

13. The decision making system according to claim 11 wherein the screen displays players on base, the number of outs remaining, and the inning number in Baseball.

14. The system according to claim 1 further comprising a game move module to display the challenging game move for the current state of the virtual game, wherein decision model module determines a possible game move from the current on-field state of the real game.
